(19) United States
(12) Patent Application Publication
(10) Pub. No.: US 2004/0080817 A1
(43) Pub. Date: Apr. 29, 2004

(54) Electric optical microscope

(75) Inventor: Katsuyoshi Yamaguchi, Hino-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 10/663,040

(22) Filed: Sep. 15, 2003

(30) Foreign Application Priority Data
Sep. 17, 2002 (JP) 2002-270529

(51) Int. Cl. G02B 21/06

(52) U.S. Cl. 359/385

(57) ABSTRACT

Allocation information indicative of optical elements corresponding to various kinds of observation methods allocated to respective operation buttons and their arrangement states is stored in a non-volatile memory, the allocation information allocated to the manipulated operation button is read from the non-volatile memory, and the optical elements are arranged in respective optical paths of an observation optical system and an illumination optical system in accordance with the allocation information.

### CROSS-REFERENCE TO RELATED APPLICATIONS

This application is based upon and claims the benefit of priority from the prior Japanese Patent Application No. 2002-270529, filed Sep. 17, 2002, the entire contents of which are incorporated herein by reference.

### BACKGROUND OF THE INVENTION

1. Field of the Invention

The present invention relates to an electric optical microscope which selectively arranges a plurality of optical elements such as a permeation filter or an object lens on optical paths and realizes a plurality of observation methods such as a bright field observation method.

2. Description of the Related Art

A microscope is used by a plurality of observation methods (which will be referred to as various kinds of observation methods hereinafter) according to use applications in a medical field, a biological field or an industrial field such as manufacture of semiconductors or manufacture of a high-capacity storage medium. These observation methods are diversely required in accordance with, e.g., diversification of minuteness or chemical characteristics of a sample as an observation target. These observation methods are, e.g., a bright field observation method, a dark field observation method, a differential interference observation method, a phase difference observation method, a fluorescent observation method, a composite observation method which is a combination of these observation methods, and others.

These observation methods are realized by arranging a plurality of optical elements on an optical path extending from an illumination light source to an eyepiece or an optical path extending from the illumination light source to a camera. The optical element is, e.g., a permeation filter, an object lens or the like.

Many microscopes which can realize various kinds of observation methods have been proposed. These proposed microscopes include, e.g., a switching mechanism which switches a plurality of optical elements and a setting mechanism which sets arrangement of the optical elements. These microscopes have a complicated setting operation in the setting mechanism. Therefore, there microscopes have a structure that ingenuity is exercised to the setting mechanism in order to facilitate the setting operation even if only slightly.

As such a microscope, there is a microscopic system disclosed in, e.g., Jpn. Pat. Appln. KOKAI Publication No. 8-179218. This microscopic system has electric inserting/removing means, detecting means, inputting means, controlling means, setting means, storing means, displaying means and others. The electric inserting/removing means inserts/removes respective optical elements, e.g., an object lens, a cube, a condenser top lens, a filter, an eyepiece and others to/from the optical path. The detecting means detects an insertion/removal state of the optical elements with respect to the optical path. The inputting means inputs a control instruction given from an operator. The controlling means receives the insertion/removal state of the optical elements from the detecting means and outputs a control command to the electric inserting/removing means in order to control a corresponding optical element to be inserted/removed in accordance with the control instruction inputted from the inputting means.

The setting means arbitrarily sets dimension data of various optical elements, e.g., a name, a magnification, a numerical aperture, a focal distance, an operating distance of the object lens. The storing means stores the dimension data of the optical elements set by the setting means, and holds the dimension data after shutting off a power supply. The displaying means displays a content of the dimension data of the various optical elements.

This microscopic system enables addition of an optical member having new dimension data to a unit of optical components. This microscopic system can optimally control an illumination system and a focusing system by using the added optical member. This microscopic system can facilitate environmental construction of the microscope and realize an improvement in the operability by retrieving the optical members.

Jpn. Pat. Appln. KOKAI Publication No. 11-23975 describes an automatic control type microscope including a revolver, inputting means, decoding means and storing means. The revolver can have a plurality of object lenses to be attached thereto and mutually switches them. The inputting means inputs code information obtained by coding attachment position information of the object lenses in the revolver and lens information of the attachable object lenses by using respective predetermined formats. The decoding means decodes the code information inputted by the inputting means. The storing means stores the attachment position information and the lens information ob the object lenses decoded by the decoding means by associating them with each other. Since this microscope receives the coded information and automatically decodes and stores the information, it considerably facilitates input of the information with respect to the microscope.

However, addition of the optical member having new dimension data to the microscope disclosed in the former publication and input of the information required for an automatic control of the microscope before an actual use disclosed in the latter publication are not frequently required.

The former publication includes setting means for arbitrarily setting dimension data of various kinds of optical elements and displaying means for displaying a content of dimension data of various kinds of optical elements. The latter publication includes inputting means for inputting code information of the attachment position information of the object lenses in the revolver and the lens information of the object lenses which can be attached to the revolver. In other words, the former and latter publications include various information setting mechanisms used to control the microscope, e.g., an information input mechanism, a display output mechanism and others in the microscope main body.

Therefore, the microscopes of these publications lead to complication and increase in size of the microscope itself against an original object of the microscope main body, i.e., observing a sample. As a result, the microscope of each publication may possibly generate a failure and increase a cost. In recent years, a demand for a reduction in space has been increased in medical and biological fields as well as an industrial field. In terms of this point, an increase in size of the microscope cannot be readily accepted.

On the other hand, even in the microscope, external peripheral devices which are so-called after-parts and others are used. The external peripheral device is, e.g., a high-speed shutter, a high-speed filter turret and others. When this external peripheral device is attached to the microscope, it is necessary to additionally connect controlling means for controlling the microscope itself, e.g., a computer as well as another computer used to control the external peripheral device. Therefore, when the external peripheral device is operated with the operation of the microscope, the operability is deteriorated. Thus, there is required the operability which is flexible and easy even when the external peripheral device is attached to the microscope.

### BRIEF SUMMARY OF THE INVENTION

According to a main aspect of the present invention, there is provided an electric optical microscope comprising: an illumination optical system which irradiates a sample with illumination light rays an observation optical system which receives observation light rays from the sample and obtains an enlarged image of the sample; a plurality of optical elements which realize a plurality of observation methods with respect to the sample when selectively arranged on respective optical paths of the illumination optical system and the observation optical system; an operation portion having arranged thereon a plurality of operation input ends used to indicate any one of a plurality of the observation methods; a storage portion which allocates operation input allocation information indicative of the optical elements selected in accordance with a plurality of the observation methods and arrangement states of the optical elements on the respective optical paths of the illumination optical system and the observation optical system to a plurality of the operation input ends, and stores them; a control portion which reads the operation input allocation information allocated to the operation portion from the storage portion upon detecting an operation to the operation input ends, and arranges the optical elements on the respective optical paths of the observation optical system and the illumination optical system in accordance with the operation input allocation information; and an information setting portion which fetches the operation input allocation information from the outside through a communication light, allocates the fetched operation input allocation information to any one of a plurality of the operation input ends, and stores it.

### BRIEF DESCRIPTION OF THE SEVERAL VIEWS OF THE DRAWING

FIG. 1 is a structural view showing a first embodiment of an electric optical microscope according to the present invention;

FIG. 2 is a structural view of a control portion and an operation portion in the microscope;

FIG. 3 is a type drawing of operation input allocation information in the microscope;

FIG. 4 is a layout drawing of operation buttons in the operation portion in the microscope;

FIG. 5 is a front partial structural view of a cube cassette in the microscope;

FIG. 6 is a side partial structural view of the cube cassette in the microscope;

FIG. 7 is a view showing positions and meanings of functions in the microscope;

FIG. 8 is a view showing positions and meanings of functions in the microscope;

FIG. 9 is a type drawing showing allocation information relative to an operation button in the microscope;

FIG. 10 is a type drawing showing allocation information relative to an operation button in the microscope;

FIG. 11 is a type drawing showing allocation information relative to an operation button in the microscope;

FIG. 12 is an allocation operation control flowchart in the microscope;

FIG. 13 is an allocation operation control flowchart in the microscope;

FIG. 14 is an allocation operation control flowchart in the microscope;

FIG. 15 is an allocation operation control flowchart in the microscope;

FIG. 16 is a structural view showing a second embodiment of an electric optical microscope according to the present invention;

FIG. 17 is a structural view of a control portion and an operation portion in the microscope;

FIG. 18 is a type drawing showing allocation information used to apply an operation control over external peripheral devices stored in a non-volatile memory in the microscope;

FIG. 19 is a view showing commands of a high-speed shutter system in the microscope;

FIG. 20 is a type drawing showing allocation information of a closing operation of the high-speed shutter system stored in the non-volatile memory in the microscope;

FIG. 21 is a type drawing showing allocation information of an opening operation of the high-speed shutter system stored in the non-volatile memory in the microscope;

FIG. 22 is an allocation operation control flowchart in the microscope;

FIG. 23 is an allocation operation control flowchart in the microscope; and

FIG. 24 is an allocation operation control flowchart in the microscope.

### DETAILED DESCRIPTION OF THE INVENTION

A first embodiment according to the present invention will now be described with reference to the accompanying drawings.

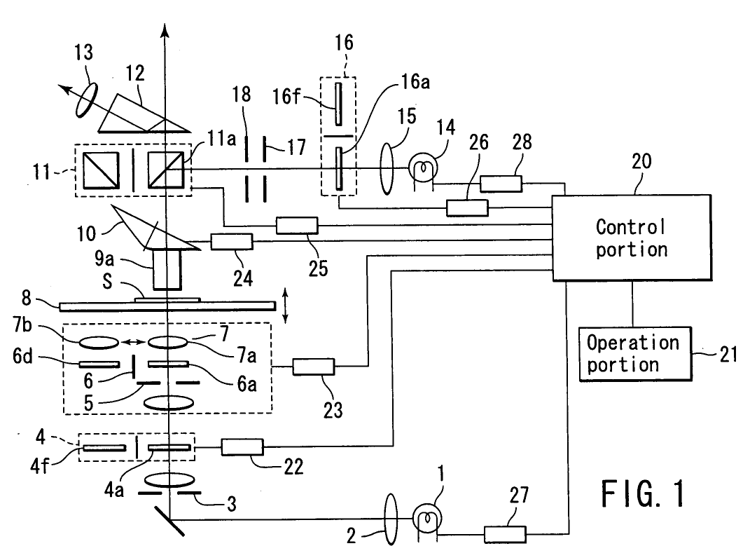

FIG. 1 is an overall structural view of an electric optical microscope. An illumination optical system will now be described. A permeation illumination light source 1 consists of, e.g., a halogen lamp. Illumination light rays emitted from the permeation illumination light source 1 are condensed in a collector lens 2, and enter a permeation filter turret 4 through a permeation field aperture 3. The permeation filter turret 4 can be switched and attached to a microscope main body B.

The permeation filter turret 4 has, e.g., six types of filters 4a to 4f attached thereto. Since the permeation filter turret 4 switches the six filters 4a to 4f, it is based on a six-stage switching mode. The respective filters 4a to 4f are, e.g., a plurality of ND filters or a plurality of correction filters. The ND filter performs a light brightness control without changing a color temperature of the permeation illumination light source 1. The correction filter carries out color correction. The permeation filter turret 4 selectively inserts an arbitrary filter among the respective ND filters or the respective correction filters into an optical path of the illumination optical system.

The illumination light transmitted through the permeation filter turret 4 illuminates an observation sample S through a permeation aperture diaphragm 5, a condenser optical element unit 6 and a condenser top lens unit 7. The observation sample S is mounted on a sample stage 8. As a result, the illumination light permeated through the permeation filter turret 4 illuminates the observation sample S from the lower side of the sample stage 8.

The condenser optical element unit 6 consists of a plurality of units 6a to 6f selectively inserted into the optical path. The condenser top lens unit 7 consists of a plurality of units 7a and 7b which are selectively inserted into the optical path. The sample stage 8 can two-dimensionally move the observation sample S in a plane orthogonal to an optical axis of an observation optical path, and it can be moved in a direction of the optical axis for focusing.

A plurality of object lenses 9a to 9f are attached to a revolver 10. The respective object lenses 9a to 9f are provided above the sample stage 8. The revolver 10 can have a plurality of the object lenses 9a to 9f to be attached thereto. The revolver 10 is rotatably disposed to, e.g., an arm end portion of the microscope. The revolver 10 can be attached and detached with respect to the microscope main body B. The revolver 10 switches any one of the respective object lenses 9a to 9f on the optical axis of the observation optical path by rotation.

A cube cassette 11 which can be attached/detached with respect to the microscope main body B is arranged on the observation optical path of the arm end portion of the microscope. The cube cassette 11 attaches, e.g., six types of filter cubes 11a to 11f which are selectively inserted in accordance with various kinds of observation methods. The various kinds of observation methods are, e.g., a bright field observation method, a dark field observation method, a differential interference observation method, a phase difference observation method, a fluorescent observation method, a composite observation method which is a combination of these observation methods. As a result, the cube cassette 11 switches the respective filter cubes 11a to 11f on six stages.

The light permeated through the cube cassette 11 is caused to diverge in two directions by a beam splitter 12. One light ray is led to an eyepiece 13. The other light ray is led to an shooting optical path.

An reflected illumination light source 14 consists of, e.g., a mercury lamp. Illumination light rays emitted from the reflected illumination light source 14 are condensed by a collector lens 15, and enter a reflected-light filter turret 16. The reflected-light filter turret 16 can be attached/detached with respect to the microscope main body B.

The reflected-light filter turret 16 has, e.g., six types of filters 16a to 16f attached thereto. Since the reflected-light filter turret 16 switches the six filters 16a to 16f, it is based on a six-stage switching mode. The respective filters 16a to 16f are a plurality of ND filters or a plurality of correction filters. The ND filter performs a light brightness control without changing a color temperature of the reflected illumination light source 14. The correction filter carries out color correction. The reflected-light filter turret 16 selectively inserts/removes an arbitrary filter among the respective ND filters or the respective correction filters to/from the optical path of the illumination optical system.

The reflected illumination light permeated through the reflected-light filter turret 16 enters, e.g., an incident-light aperture diaphragm 17, a reflected-light field aperture 18 and the filter cube 11a in the cube cassette 11, and epi-illuminates the observation sample S through the object lens 9a.

A fluorescence or reflected light rays from the observation sample S can be obtained as an observation light ray. The observation light rays are transmitted through, e.g., the object lens 9a and the cube cassette 11, and is caused to diverge in two directions by the beam splitter 12. One observation light ray is led to the eyepiece 13. As a result, an enlarged image of the observation sample S can be obtained. The other observation light ray is led to the shooting optical path.

A control portion 20 and an operation portion 21 of the electric optical microscope will Now be described.

The control portion 20 applies an operation control over a permeation filter turret drive portion 22, a condenser unit drive portion 23, a revolver drive portion 24, a cube cassette drive portion 25, a reflected-light filter turret drive portion 26, a permeated illumination light control portion 27, and a reflected illumination control portion 28.

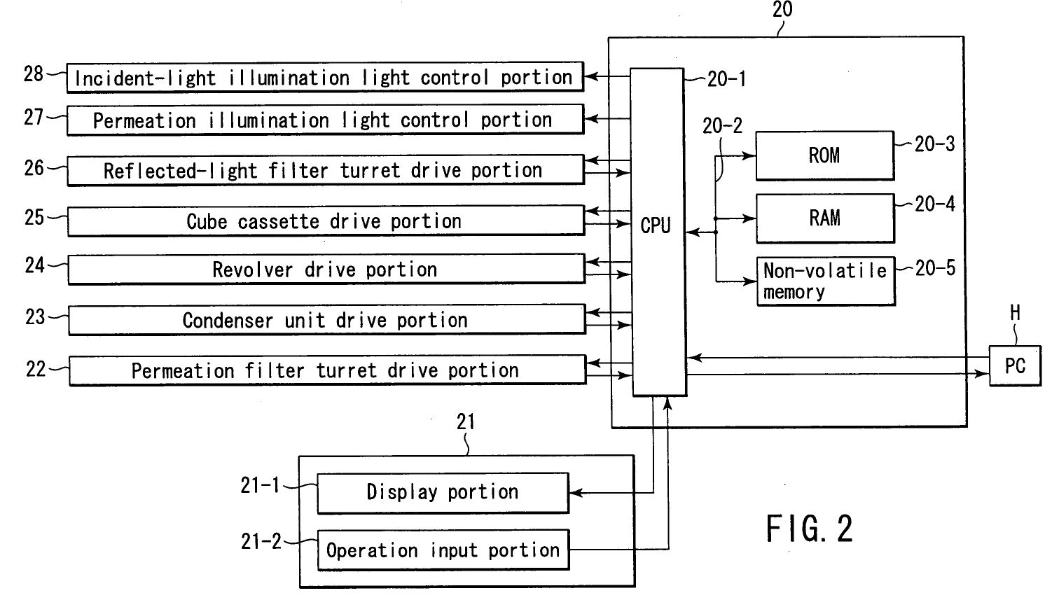

FIG. 2 is a structural view showing the control portion 20 and the operation portion 21. To a CPU 20-1 are connected an ROM 20-3, an ROM 20-4 and a non-volatile memory 20-5 through a CPU bus 20-2. The ROM 20-3 stores therein a program in which a control content is written. The ROM 20-4 stores therein data for a control arithmetic operation.

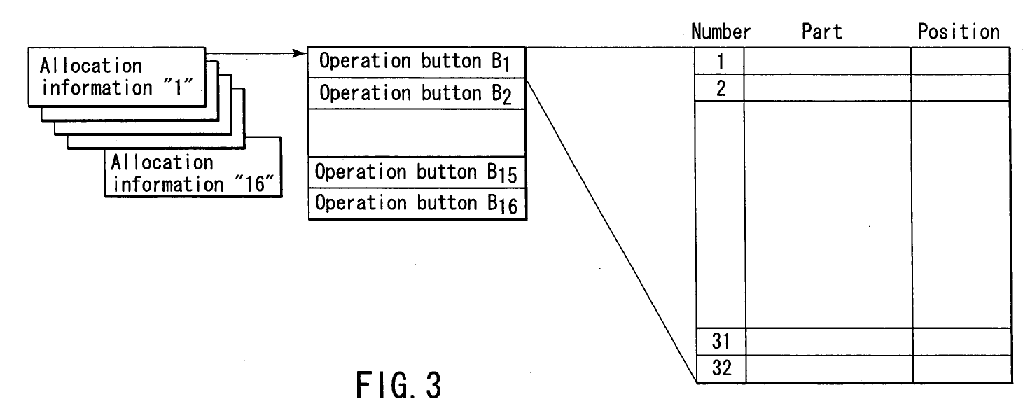

The non-volatile memory 20-5 consists of, e.g., an EEPROM, an NVRAM or a flash memory. Necessary information is stored or read into/from the non-volatile memory by executing a program. The non-volatile memory 20-5 stores therein operation input allocation information as shown in FIG. 3.

Upon receiving an operation input from the operation portion 21, the CPU 20-1 applies an operation control to the permeation filter turret drive portion 22, the condenser unit drive portion 23, the revolver drive portion 24, the cube cassette drive portion 25, the reflected-light filter turret drive portion 26, the permeated illumination light control portion 27 and the reflected illumination control portion 28 in accordance with operation input allocation information stored in the non-volatile memory 20-5.

To the control portion 20 is provided an external interface (I/F), e.g., RS-232C, USB or Ethernet as external communicating means. The control portion 20 connects an external host device H such as a personal computer PC through the external I/F.

The control portion 20 transmits/receives commands from, e.g., a personal computer PC through the external I/F, and performs the same operation control as an operation control over the respective drive portions, i.e., the permeation filter turret drive portion 22, the condenser unit drive portion 23, the revolver drive portion 24, the cube cassette drive portion 25, the reflected-light filter turret drive portion 26, the permeated illumination light control portion 27 and the reflected illumination control portion 28 when the operation portion 21 is operated.

The control portion 20 exchanges information with the external host device H.

The operation portion 21 has a display portion 21-1 and an operation input portion 22-2. The operation portion 21 is connected to the CPU 20-1, and supplies an operation signal from an operation input portion 21-2 to the CPU 20-1.

The operation portion 21 displays in a display portion 21-2 each operation status or each position information or the like of the permeation filter turret drive portion 22, the condenser unit drive portion 23, the revolver drive portion 24, the cube cassette drive portion 25, the reflected-light filter turret drive portion 26, the permeated illumination light control portion 27 and the reflected illumination control portion 28.

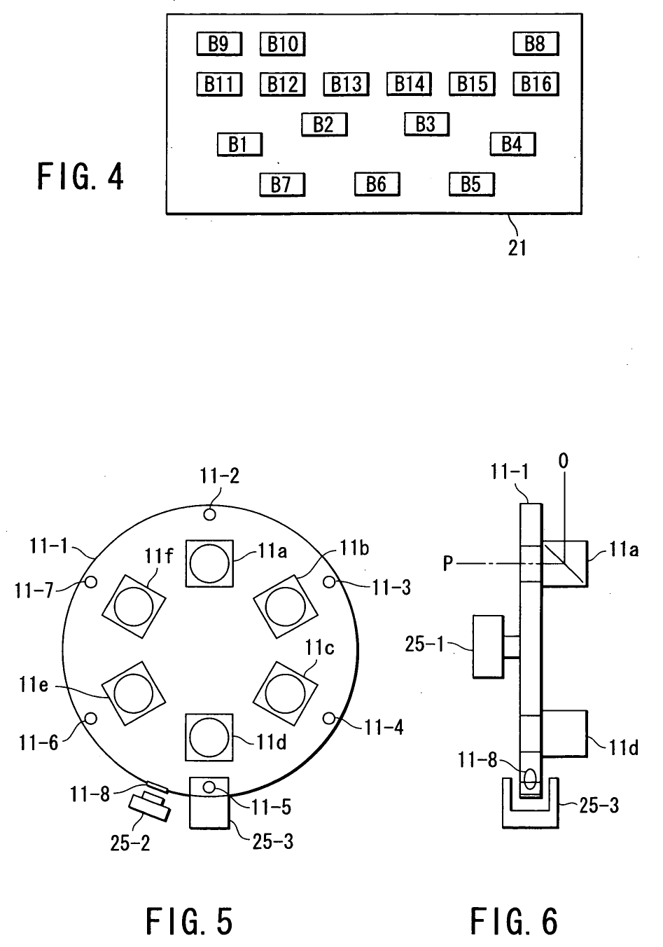

FIG. 4 is a layout drawing of operation buttons in the operation portion 21. On the operation portion 21 are arranged, e.g., a plurality of operation buttons B₁ to B₁₆. The respective operation buttons B₁ to B₁₆ are so-called illumination type button switches that light emitting elements such as light emitting diodes are incorporated therein. The respective operation buttons B₁ to B₁₆ are switched off, switched on or blink by commands from the CPU 20-1.

The permeation filter turret drive portion 22 receives a drive signal transmitted from the control portion 22, and drives to rotate the permeation filter turret 4 by using this drive signal. As a result, the respective filters 4a to 4f are inserted/removed into/from the optical path.

The condenser unit drive portion 23 receives a drive signal transmitted from the control portion 22, and drives to adjust the permeation aperture diaphragm 5 by using this drive signal. The condenser unit drive portion 23 receives a drive signal transmitted from the control portion 22, and drives the condenser unit optical element unit 6 and the condenser top lens unit 7 to rotate by using this drive signal. As a result, a plurality of the units 6a to 6f of the condenser optical element unit 6 are inserted/removed into/from the optical path. A plurality of the units 7a and 7b of the condenser top lens unit 7 are inserted/removed into/from the optical path.

The revolver drive portion 24 receives a drive signal fed from the control portion 20, and drives the revolver 10 to rotate by using this drive signal. Consequently, the respective object lenses 9a to 9f are inserted/removed into/from the optical path.

The cube cassette drive portion 25 receives a drive signal transmitted from the control portion 20, and drives the cube cassette 11 to rotate by using this drive signal. As a result, the respective filter cubes 11a to 11f are inserted/removed into/from the optical path.

The reflected-light filter turret drive portion 26 receives a drive signal fed from the control portion 20, and drives the reflected-light filter turret 16 to rotate by using this drive signal. As a result, the respective filters 16a to 16f are inserted/removed into/from the optical path.

The permeated illumination light control portion 27 receives a light control signal supplied from the control portion 20, and controls the light of the permeation illumination light source 1 by using this light control signal.

The incident-light illumination control portion 28 receives a light control signal supplied from the control portion 20, and controls the light of the reflected illumination light source 14 by using this light control signal.

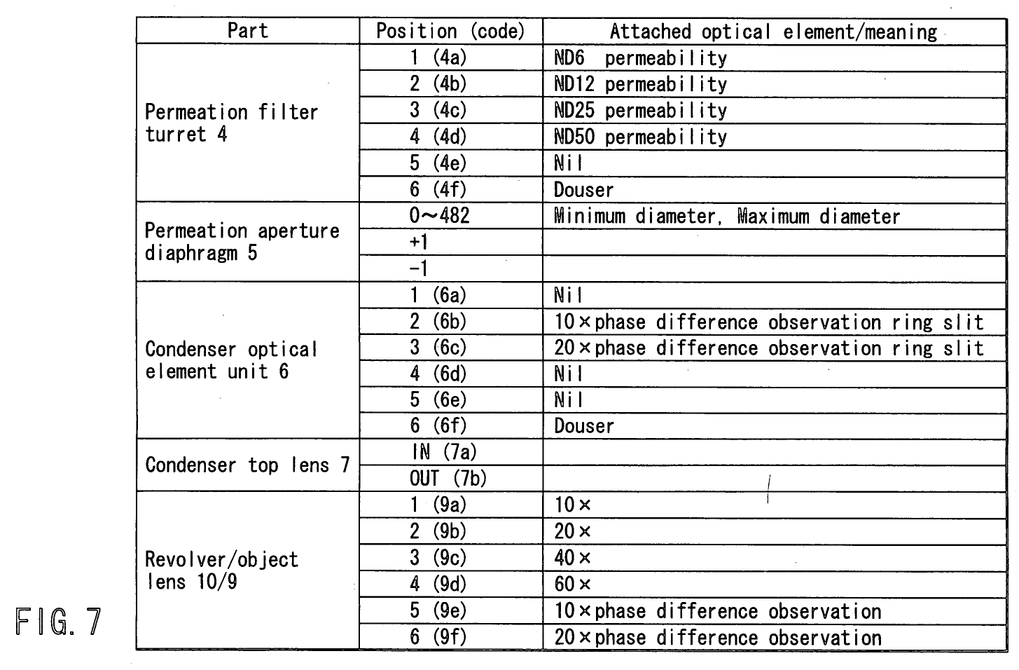

FIGS. 5 and 6 are structural views of the cube cassette 11. FIG. 5 is a front partial view and FIG. 6 is a side partial view. The cube cassette 11 has a circular plate 11-1 provided thereto. A shaft of a pulse motor 25-1 of the cube cassette drive portion 25 is connected to a central portion of the circular plate 11-1. As a result, the circular plate 11-1 can rotate around the central axis by driving of the pulse motor 25-1. When the circular plate 11-1 appropriately rotates by driving of the pulse motor 25-1, any one of the filter cubes 11a to 11f detachably held by the circular plate 11-1 is arranged on an optical path OP.

A magnet 11-8 is attached at one position of an outer peripheral portion of the circular plate 11-1. The magnet 11-8 detects an original point position of the circular plate 11-1. A hole element 25-2 of the cube cassette drive portion 25 detects an original point position of the circular plate 11-1. When the circular plate 11-1 is placed at the original point position, the magnet 11-8 is arranged at a position opposed to the hole element 25-2. As a result, when the hole element 25-2 detects the magnet 11-8, a fact that the circular plate 11-1 is arranged at the original point position is detected.

On the other hand, respective opening portions 11-2 to 11-7 are formed at an edge portion of the circular plate 11-1. The respective opening portions 11-2 to 11-7 correspond to positions of the respective filter cubes 11a to 11f. The respective opening portions 11-2 to 11-7 correctly position and arrange any one of the filter cubes 11a to 11f on the optical path OP.

A photo interrupter 25-3 of the cube cassette drive portion 25 is provided at the outer peripheral portion of the photo interrupter 25-3. The photo interrupter 25-3 detects the respective opening portions 11-2 to 11-7 at the edge portion of the circular plate 11-1.

Therefore, for example, when the filter cube 11a is arranged on the optical path OP, the photo interrupter 25-3 of the cube cassette drive portion 25 detects existence of the opening portion 11-5. As a result, the filter cube 11a is correctly positioned and arranged on the light path OP.

It is to be noted that the permeation filter turret 4, the revolver 10 and the reflected-light filter turret 16 have provided thereto the magnet and the hole element for original point position detection and the opening portions and the photo interrupter for positioning and arrangement like the above. As a result, it is possible to perform original point detection and a positioning control to a desired position of the permeation filter turret 4, the revolver 10 and the reflected-light filter turret 16.

The non-volatile memory 20-5 stores therein operation input allocation information as shown in FIG. 3. The operation input allocation information is indicative of an arrangement state of each optical element selected in accordance with, e.g., the bright field observation method, the dark field observation method, the differential interference observation method, the phase difference observation method, the fluorescent observation method, the composite observation method which is a combination of these observation methods, and others.

The respective optical elements are the permeation filter turret 4, the condenser optical element unit 6, the condenser top lens unit 7, the object lenses 9a to 9f, the cube cassette 11 and the like constituting the observation optical system. Further, the respective optical elements are the permeation illumination light source 1, the reflected illumination light source 14 and the like constituting the illumination optical system. The operation input allocation information is allocated to the respective operation buttons B₁ to B₁₆ of the operation portion 21.

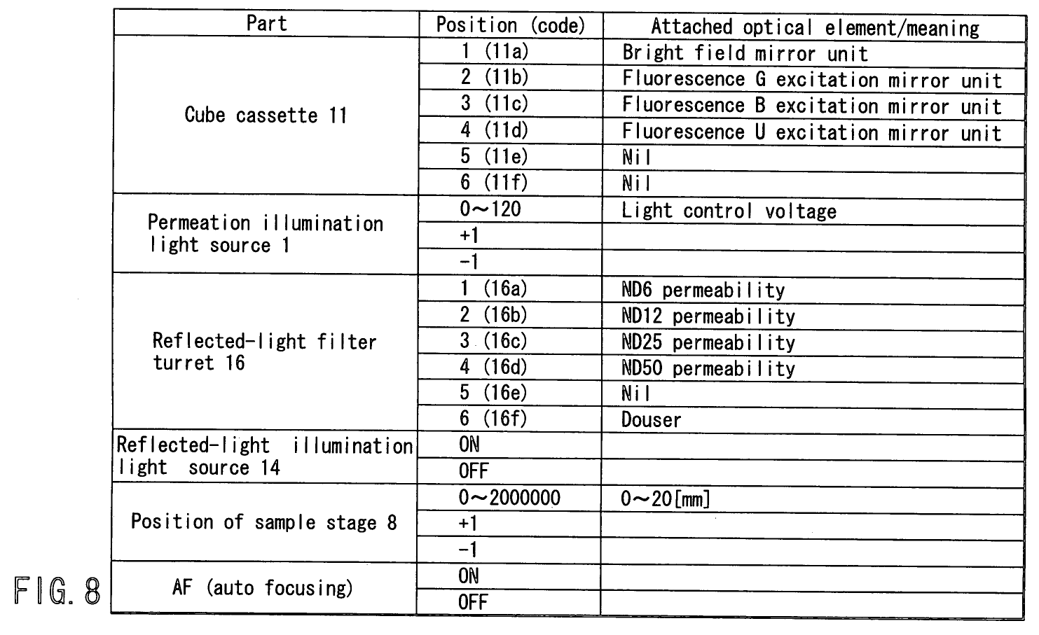

The operation input allocation information will now be concretely described. Each electric mechanism of the electric optical microscope has attached thereto the respective optical elements shown in columns of parts in FIGS. 7 and 8. For example, the permeation filter turret 4 depicted in FIG. 7 allocates six types of filters 4a to 4f to columns “1” to “6” of positions. For example, the filter 4a has an ND “6” and a transmittance 6% as shown in a column of attached optical elements/meanings. The filter 4b has an ND “12” and a transmittance 12%.

In regard to the permeation aperture diaphragm 5, an aperture “0 to 482” is set in the column of positions. A minimum aperture is “0” whilst a maximum aperture is “482”, and an aperture which continuously varies is set.

As to the revolver/object lens 10 and 9, the respective object lenses 9a to 9f are allocated to columns “1” to “6” of positions. For example, the object lens 9a has a magnification “10×”. The object lens 9b has a magnification “20×”.

Likewise, the operation input allocation information sets positions, positions relative to auto focusing (AF) and attached optical elements/meanings of the condenser optical element unit 6, the condenser top lens unit 7, the cube cassette 11, the permeation illumination light source 1, the incident-light filter target 16, the reflected illumination light source 14 and the sample stage 8.

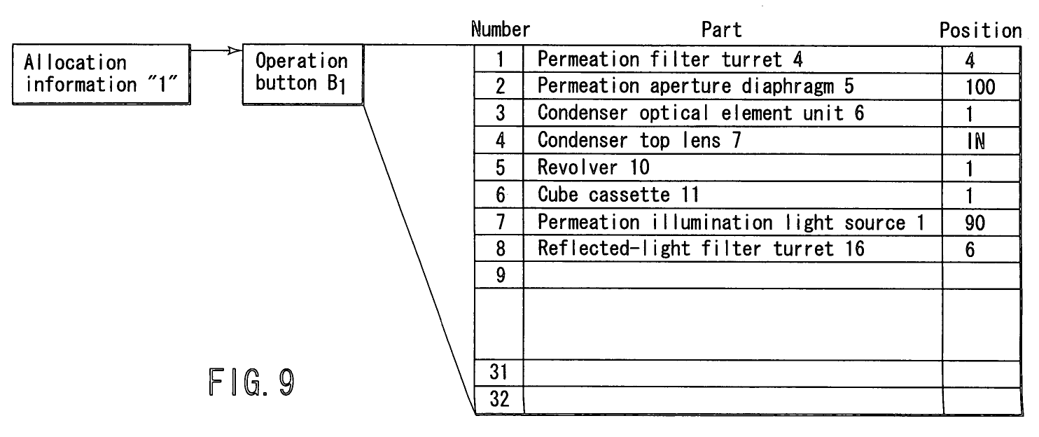

The operation input allocation information has, e.g., allocation information “1” to “16” in accordance with each file as shown in FIG. 3. For example, the allocation information “1” sets switching operations of the transmission bright field observation method using the object lens 9a with a magnification “10×” to numbers “1” to “8” with respect to the operation button B₁ as shown in FIG. 9.

That is, the permeation filter turret 4 is switched to a position “4: (filter 4c)”. The permeation aperture diaphragm 5 is switched to a position “100”. The condenser optical element unit 6 is switched to a position “1: (unit 6a)”. The condenser top lens 7 is switched to a position “IN: (unit 7a)”. The revolver 10/object lens 9 is switched to a position “1: (object lens 9a)”. The cube cassette 11 is switched to a position “1: (filter cube 11a)”. The permeation illumination light source 1 is light-controlled to a position “90: (voltage 9V)”. The reflected-light filter turret 16 is switched to a position “6: (filter 16f)”. It is to be noted that the reflected-light filter turret 16 is switched to the position “6” in order to prevent light-transmittance of the reflected illumination light source 14 by a douser attached thereto and eliminate an adverse affection due to the stray light to the transmission bright field observation.

In regard to the operation button B₂ of the allocation information “1”, switching operations of the incident-light fluorescent observation method using the object lens 9b with a magnification “20×” are set to numbers “1” to “6”. That is, the condenser optical element unit 6 is switched to a position “6: (unit 6f)”. The condenser top lens 7 is switched to a position “OUT: (unit 7b)”. The revolver 10/object lens 9 is switched to a position “2: (object lens 9b)”. The cube cassette 11 is switched to a position “3: (filter cube 11c)” The reflected illumination light source 14 is light-controlled to a position “ON: lighting”. The reflected-light filter turret 16 is switched to a position “5: (filter 16e)”.

The condenser optical element unit 6 is switched to a position “6” in order to prevent light-transmittance of the permeation illumination light source 1 by the douser attached thereto and eliminate an adverse affection due to the stray light to the incident-light fluorescent observation. Further, the condenser top lens 7 is switched to the position “OUT” in order to eliminate an adverse affection to the incident-light fluorescent observation due to self-fluorescence by the top lens.

In regard to the operation button B₃ of the allocation information “1”, allocation information which explains a fetching operation from the external host device H such as a personal computer PC is set.

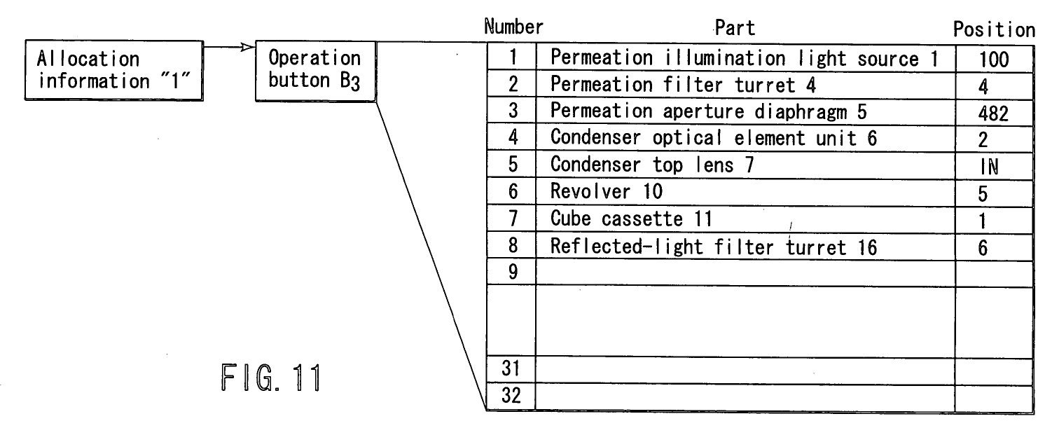

That is, as to the operation button B₃, switching operations of the phase difference observation method using the object lens 9e with a magnification “10×” are set to the numbers “1” to “8” as shown in FIG. 11. The permeation illumination light source 1 is switched to a position “100: (voltage 10V)”. The permeation filter turret 4 is switched to a position “4: (filter 4d)”. The permeation aperture diaphragm 5 is switched to a position “482: (maximum diameter)”. The condenser optical element unit 6 is switched to a position “2: (unit 6a)”. The condenser top lens 7 is switched to a position “IN: (unit 7a)”. The revolver 10/object lens 9 is switched to a position “5: (object lens 9e)”. The cube cassette 11 is switched to a position “1: (filter cube 11a)”. The reflected-light filter turret 16 is switched to a position “6: (filter 16f)”.

The CPU 20-1 reads the allocation information indicative of the optical elements allocated to the manipulated operation buttons B₁ to B₁₆ and allocation information indicative of arrangement states from the non-volatile memory 20-5. The CPU 20-1 arranges the optical elements on the respective optical paths of the observation optical system and the illumination optical system in accordance with the read allocation information.

The CPU 20-1 fetches information from, e.g., the external personal computer PC, i.e., the allocation information indicative of the optical elements selected in accordance with various kinds of observation methods and the arrangement states through the external I/F. The CPU 20-1 allocates this allocation information to any one of the respective operation buttons B₁ to B₁₆ and stores it in the non-volatile memory 20-5.

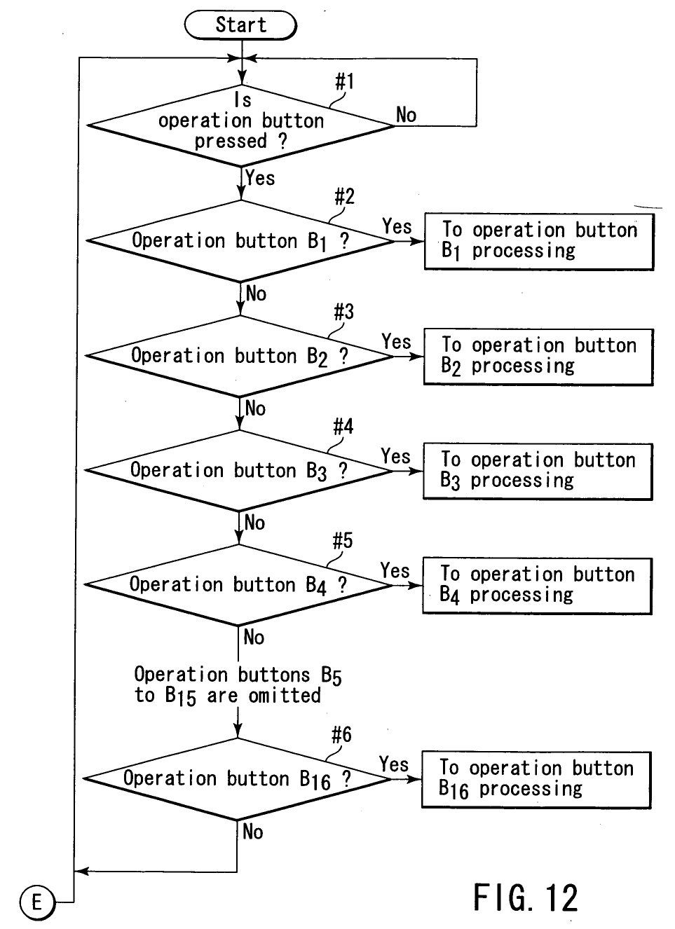

An operation of the electric optical microscope having the above-described structure will now be described in accordance with allocation operation control flowcharts shown in FIGS. 12 to 15.

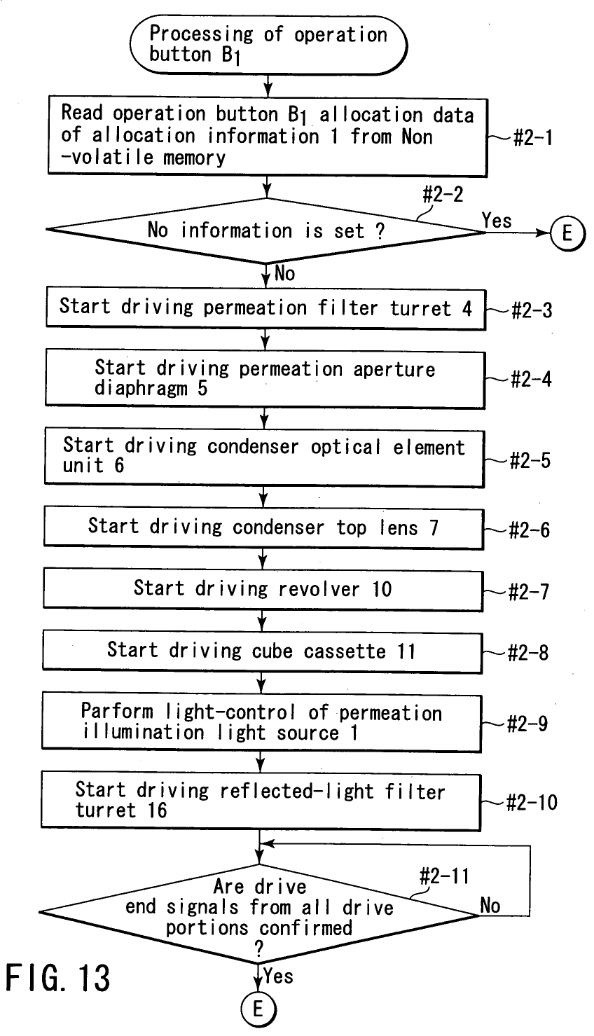

At a step #1, the CPU 20-1 judges presence/absence of operations relative to the respective operation buttons B₁ to B₁₆. When the operation button B₁ of the operation portion 21 is pressed, the CPU 20-1 shifts to a step #2 and detects a pressing operation of the operation button B₁. The CPU 20-1 starts processing of the operation button B₁ shown in FIG. 13, i.e., driving of each electric mechanism corresponding to the operation button B₁.

At a step #2-1, the CPU 20-1 reads allocation information “1” shown in FIG. 9 selected by a DIP-SW provided to the control portion 20 from the non-volatile memory 20-5. Incidentally, if the read allocation information “1” does not have setting of the allocation information in any column, the CPU 20-1 does not perform any processing operation and waits for an operation input of the next operation buttons B₁ to B₁₆ at a step #2-2.

The CPU 20-1 issues to the permeation filter turret drive portion 22 a command to start driving the permeation filter turret 4 to the position “4: (4c)” in accordance with the allocation information “1” read from the non-volatile memory 20-5 at a step #2-3.

Subsequently, at a step #2-4, the CPU 20-1 issues to the condenser unit drive portion 23 a command to start driving the permeation aperture diaphragm 5 to the position “100”.

Then, at a step #2-5, the CPU 20-1 issues a command to start driving the condenser optical element unit 6 to the position “1: (6a)”.

Subsequently, at a step #2-6, the CPU 20-1 issues a command to start driving the condenser top lens 7 to the position “IN: (7a)”.

Thereafter, at a step #2-7, the CPU 20-1 issues to the revolver drive portion 24 a command to drive the revolver 10/object lens 9 to the position “1: (9a)”.

Then, at a step #2-8, the CPU 20-1 issues to the cube cassette drive portion 25 a command to start driving the cube cassette 11 to the position “1: (11a) ”.

Subsequently, at a step #2-9, the CPU 20-1 issues to the transmission illumination light control portion 27 a command to light-control the permeation illumination light source 1 to the position “90: (9V)”.

Thereafter, at a step #2-10, the CPU 20-1 issues to the reflected-light filter turret drive portion 26 a command to start driving the reflected-light filter turret 16 to the position “6: (16f)”.

Then, at a step #2-11, the CPU 20-1 monitors a drive end signal from each drive portion. Subsequently, upon confirming the drive end signals from all the drive portions, the CPU 20-1 terminates the switching control corresponding to the allocation of the operation button B₁, and waits for an operation input of the next operation buttons B₁ to B₁₆.

As a result, the filter 4c with an ND 25 and a transmittance 25% in the permeation filter turret 4 is arranged in the optical path. The transmission aperture diaphragm 25 is switched to an aperture: 100. The condenser optical element unit 6 has a pipe arranged for the bright field observation. The condenser top lens 7 is arranged on the optical path. The object lens 9 is switched to the object lens 9a with a magnification “10×”. The cube cassette 11 arranges a bright field mirror unit on the optical path. The permeation illumination light source 1 is light-controlled to the brightness obtained by application of a voltage 9V. The reflected-light filter turret 16 prevents light-transmittance of the incident-light illumination by arranging the douser on the incident-light illumination optical path. As a result, the transmission bright field observation using the object lens 9a with a magnification “10×” can be realized.

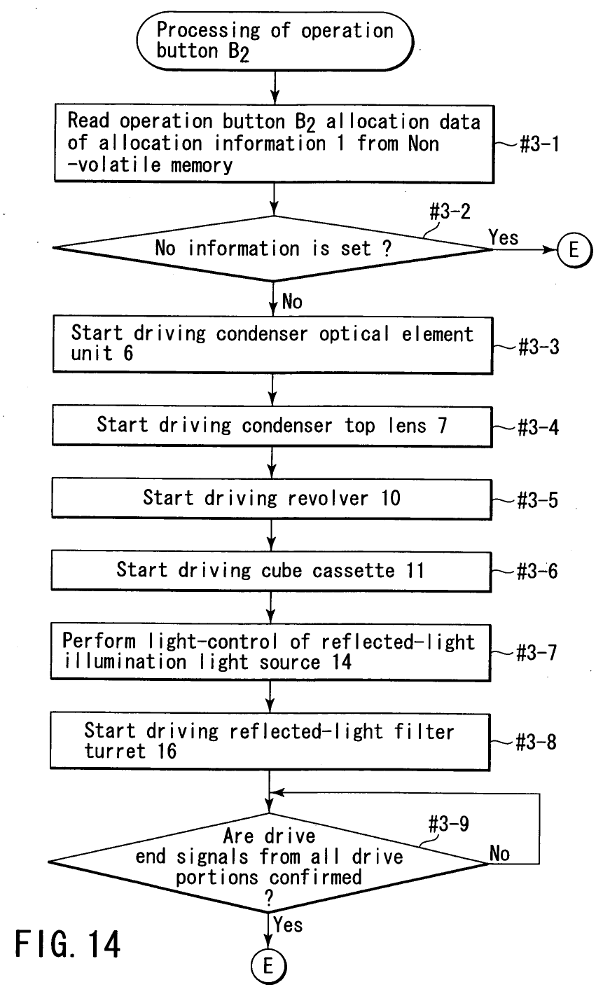

On the other hand, when the operation button B₂ of the operation portion 21 is pressed, the CPU 20-1 detects a pressing operation of the operation button B₂ at a step #3 shown in FIG. 12. Then, the CPU 20-1 starts processing of the operation button B₂ shown in FIG. 14, i.e., driving each electric mechanism corresponding to the operation button B₂.

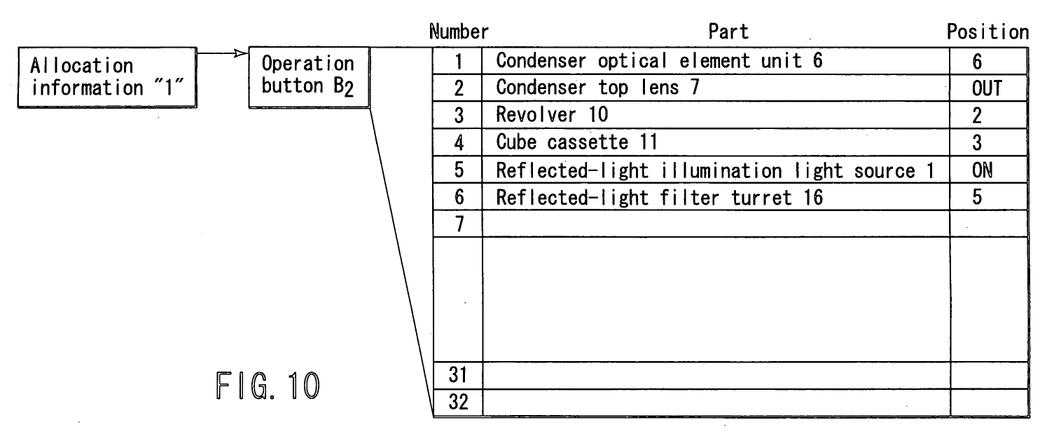

At a step #3-1, the CPU 20-1 reads the allocation information “1” shown in FIG. 10 selected by the DIP-SW provided to the control portion 20 from the non-volatile memory 20-5. Incidentally, if the read allocation information “1” does not have setting of the allocation information in any column, the CPU 20-1 does not perform any processing and waits for an operation input of the next operation buttons B₁ to B₁₆ at a step #3-2.

Then, at a step #3-3, the CPU 20-1 issues to the condenser unit drive portion 23 a command to start driving the condenser optical element unit 6 to the position “6: (6f)” in accordance with the allocation information “1” read from the non-volatile memory 20-5.

Subsequently, at a step #3-4, the CPU 20-1 issues a command to drive the condenser top lens 7 to the position “OUT: (7b)”.

Thereafter, at a step #3-5, the CPU 20-1 issues to the revolver drive portion 24 a command to start driving the revolver 10/object lens 9 to the position “2: (9b)”.

Then, at a step #3-6, the CPU 20-1 issues to the cube cassette drive portion 25 a command to drive the cube cassette 11 to the position “3: (11c)”.

Subsequently, at a step #3-7, the CPU 20-1 light-controls the reflected illumination control portion 28 to set the reflected illumination light source 14 to the position “ON: (lighting)”.

Thereafter, at a step #3-8, the CPU 20-1 issues to the reflected-light filter turret drive portion 26 a command to start driving the reflected-light filter turret 16 to the position “5: (16e)”.

Then, at a step #3-9, the CPU 20-1 monitors a drive end signal from each drive portion. Subsequently, upon confirming the drive end signals from all the drive portions, the CPU 20-1 terminates the switching control corresponding to the allocation of the operation button B₂, and waits for an operation input of the next operation buttons B₁ to B₁₆.

As a result, the condenser optical element unit 6 arranges the douser on the optical path. The condenser top lens 7 is removed from the optical path. The object lens 9 is switched to the object lens 99b with a magnification “20×”. The cube cassette 11 arranges a fluorescence B excitation mirror unit on the optical path. The reflected illumination light source 14 is lighted. The reflected-light filter turret 16 arranges a pipe in the optical path. As a result, the incident-light illumination is transmitted 100%. Consequently, the incident-light fluorescent observation method using the object lens 9b with the magnification “20×” can be realized.

An operation when setting the operation input allocation information from the external host device H will Now be described. The external host device H is, e.g., a personal computer PC. The operation in this example corresponds to a case that the phase difference observation method with a magnification “10×” is set to, e.g., the operation button B₃ of the allocation information “1”.

The CPU 20-1 receives, e.g., the following command from the personal computer PC through the external I/F:

“memory1,3,TL=100,TF=4,TA=482,CD=2,CDT=IN,REV=5,OC=1,RF=6”

Then, the CPU 20-1 erases stored data in a corresponding area of the non-volatile memory 20-5 and newly writes data in accordance with parameters of the command.

That is, the CPU 20-1 starts setting of the operation input allocation information by using the parameter “memory” in the command. The CPU 20-1 determines as a corresponding area the allocation information “1” stored in the non-volatile memory by using a first parameter “1” in the command.

Then, the CPU 20-1 determines the operation button B₃ from the allocation information “1” as a setting target based on the next parameter “3”.

Subsequently, the CPU 20-1 sets a number as “1” based on a parameter “TL=100”, sets a part as the permeation illumination light source 1, and determines a position as “100”.

In this manner, the CPU 20-1 sequentially interrupts the respective parameters in the command. As a result, the CPU 20-1 writes the following operation input allocation information in the non-volatile memory 20-5 with respect to the manipulation of the operation button B₃ of the allocation information “1” as shown in FIG. 11. That is, the permeation illumination light source 1 is switched to the position “100: (10V)”. The permeation filter turret 4 is switched to the position “4: (4d)”. The permeation aperture diaphragm 5 is switched to the position “482: (maximum diameter)”. The condenser optical element unit 6 is switched to the position “2: (6a)”. The condenser top lens 7 is switched to the position “IN: (7a)”. The revolver 10/object lens 9 is switched to the position “5: (9e)”. The cube cassette 11 is switched to the position “1: (11a)”. The reflected-light filter turret 16 is switched to the position “6: (16f)”.

It is to be noted that the method which receives the command from the personal computer PC by the CPU 20-1 uses, e.g., RS-232C as an I/F of the personal computer PC. By doing so, using terminal software or the like attached to a general operating system (OS) of the personal computer PC enables a user to readily set allocation of a combination of desired optical elements of the electric optical microscope to the arbitrary operation buttons B₁ to B₁₆.

The actual electric optical microscope realizes various kinds of observation methods by operations of the respective drive portions according to the operation input allocation information which has been already stored in the electric optical microscope. As a result, the external host device H such as an external personal computer PC is no longer required.

On the other hand, setting of the operation input allocation information of the electric optical microscope can be performed by using allocation software such as an applet on a Web server through the Internet. Abundant functions of an Internet browser, especially a GUI (Graphical User interface) function can be utilized. As a result, setting of the operation input allocation information to the electric optical microscope becomes comfortable and secure. Furthermore, special application software used to set the operation input allocation information of the electric optical microscope on a user side is not required.

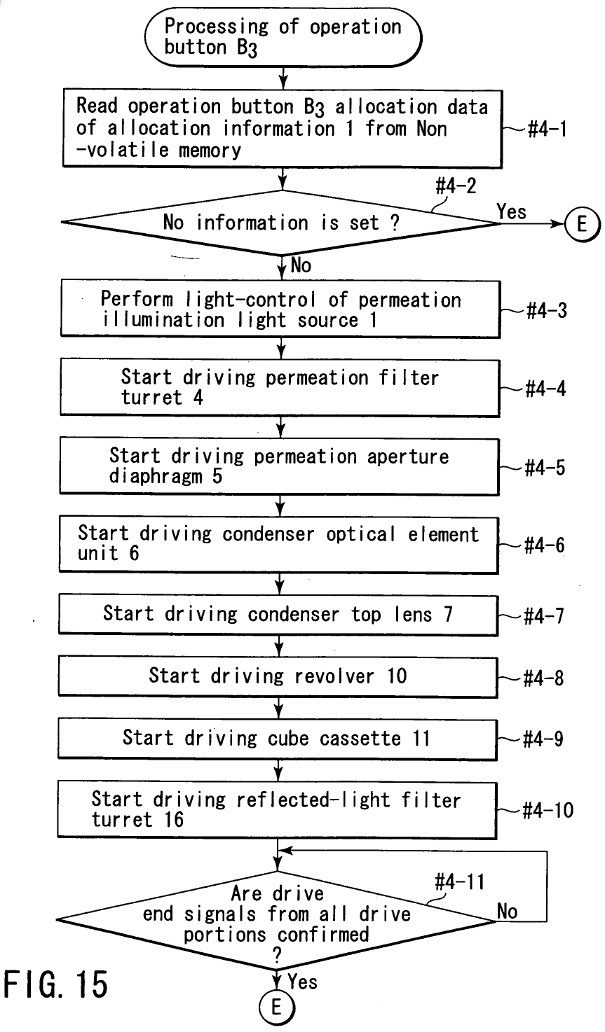

Subsequently, when the operation button B₃ of the operation portion 21 is pressed, the CPU 20-1 detects a pressing operation of the operation button B₃ at a step #4 shown in FIG. 12. Then, the CPU 20-1 starts processing of the operation button B₃ shown in FIG. 15, i.e., driving of each electric mechanism corresponding to the operation button B₃.

First, at a step #4-1, the CPU 20-1 reads the allocation information “1” selected by the DIP-SW provided to the control portion 20 from the nonvolatile memory 20-5. Incidentally, if the read allocation information “1” does not have setting of the allocation information in any column, the CPU 20-1 does not perform any processing operation and waits for an operation input of the next operation buttons B₁ to B₁₆ at a step #4-2.

Then, at a step #4-3, the CPU 20-1 issues to the transmission illumination light control portion 27 a command to light-control the permeation illumination light source 1 to the position “100 (10V)” in accordance with the allocation information “1” read from the non-volatile memory 20-5.

Subsequently, at a step #4-4, the CPU 20-1 issues to the permeation filter turret drive portion 22 a command to start driving the permeation filter turret 4 to the position “4: (4d)”.

Thereafter, at a step #4-5, the CPU 20-1 issues to the condenser unit drive portion 23 a command to start driving the permeation aperture diaphragm 5 to the position “482 (maximum diameter)”.

Then, at a step #4-6, the CPU 20-1 issues a command to start driving the condenser optical element unit 6 to the position “2: (6b)”.

Next, at a step #4-7, the CPU 20-1 issues a command to start driving the condenser top lens 7 to the position “OUT: (7b)”.

Subsequently, at a step #4-8, the CPU 20-1 issues to the revolver drive portion 24 a command to start driving the revolver 10/object lens 9 to the position “5: (9e)”.

Thereafter, at a step #4-9, the CPU 20-1 issues to the cube cassette drive portion 25 a command to start driving the cube cassette 11 to the position “1: (11a) ”.

Then, at a step #4-10, the CPU 20-1 issues to the reflected-light filter turret drive portion 26 a command to start driving the reflected-light filter turret 16 to the position “6: (16f)”.

Subsequently, at a step #4-11, the CPU 20-1 monitors a drive end signal from each drive portion. Then, upon confirming the drive end signals from all the drive portions, the CPU 20-1 terminates the switching control corresponding to the allocation of the operation button B₃, and waits for an operation input of the next operation buttons B₁ to B₁₆.

As a result of the operation input of the operation button B₃, the permeation illumination light source 1 is light-controlled to the brightness obtained by application of a voltage 10 V. The permeation filter turret 4 arranges the filter 4d with an ND 50 and a transmittance 50% on the optical path. The permeation aperture diaphragm 5 is switched to an aperture with a maximum diameter. The condenser optical element unit 6 arranges a phase difference observation ring slit with a magnification “10×” on the optical path. The condenser top lens 7 is arranged on the optical path. The object lens 9 is switched to one with a magnification “10×” for phase difference observation. The cube cassette 11 arranges the bright field mirror unit on the optical path. The reflected-light filter turret 16 prevents light-transmittance of the incident-light illumination by arranging the douser on the incident-light illumination optical path. As a result, the phase difference observation using the object lens 9e with a magnification “10×” can be realized.

Likewise, when the operation buttons B₄ to B₁₆ are manipulated, the CPU 20-1 reads the allocation information allocated to the operation buttons B₄ to B₁₆ from the non-volatile memory 20-5 and arranges the optical elements on the respective optical paths of the observation optical system and the illumination optical system in accordance with the allocation information.

As described above, according to the first embodiment, the allocation information allocated to the respective operation buttons B₁ to B₁₆ is stored in the non-volatile memory 20-5, the allocation information allocated to the manipulated operation buttons B₁ to B₁₆ is read from the non-volatile memory 20-5, and the optical elements are arranged on the respective optical paths of the observation optical system and the illumination optical system in accordance with the allocation information.

As a result, a plurality of the optical elements, e.g., the permeation filter turret 4, the condenser optical element unit 6, the condenser top lens unit 7, the object lenses 9a to 9f and the cube cassette 11 constituting the observation optical system, and the permeation illumination light source 1, the reflected illumination light source 14 or the like constituting the illumination optical system can be selectively arranged on the optical paths in accordance with various kinds of observation methods such as the bright field observation method, the dark field observation method, the differential interference observation method, the phase difference observation method, the fluorescent observation method, a composite observation method as a combination of these observation methods, thereby realizing various kinds of the observation methods.

The allocation information is fetched from, e.g., the external personal computer PC through the external I/F, allocated to any one of the respective operation buttons B₁ to B₁₆, and stored in the non-volatile memory 20-5. As a result, a special input mechanism or display output mechanism used to set the allocation information is no longer necessary, and a housing of the electric optical microscope can be minimized. Moreover, the operability is improved, and a cost can be reduced. In recent years, since a demand to reduce a space has been increased in respective fields, i.e., the industrial field, the medical field and the biological field, the minimized electric optical microscope can be readily accepted.

In the non-volatile memory 20-5 can be stored only the allocation information of a desired observation method among various kinds of observation methods such as the bright field observation method, the dark field observation method, the differential interference observation method, the phase difference observation method, the fluorescent observation method, a composite observation method as a combination of these observation methods. Additionally, the allocation information of a required observation method can be stored in the non-volatile memory 20-5 when it is necessary. Addition, change and deletion of the allocation information can be easily performed in the non-volatile memory 20-5.

When a command from the personal computer PC is received by the CPU 20-1, using, e.g., RS-232C as an I/F of the personal computer PC enables easy allocation of a combination of desired optical elements in the electric optical microscope to arbitrary operation buttons B₁ to B₁₆.

Further, in an actual electric optical microscope operation, since various kinds of observation methods are realized by operating each drive portion in accordance with the previously stored operation input allocation information, it is not necessary to receive the operation input allocation information from the external host device H such as a personal computer PC every observation and store it in the non-volatile memory 20-5.

Setting of the operation input allocation information of the electric optical microscope can be performed by using application software such as an applet on a Web server through the Internet. Abundant functions of an Internet browser, especially a GUI function can be utilized, and hence setting of the operation input allocation information to the electric optical microscope becomes comfortable and secure. Furthermore, special application software used to set the operation input allocation information of the electric optical microscope is not required on a user side.

A second embodiment according to the present invention will now be described. It is to be noted that like reference numerals denote parts equal to those in FIG. 1, thereby eliminating their detailed description.

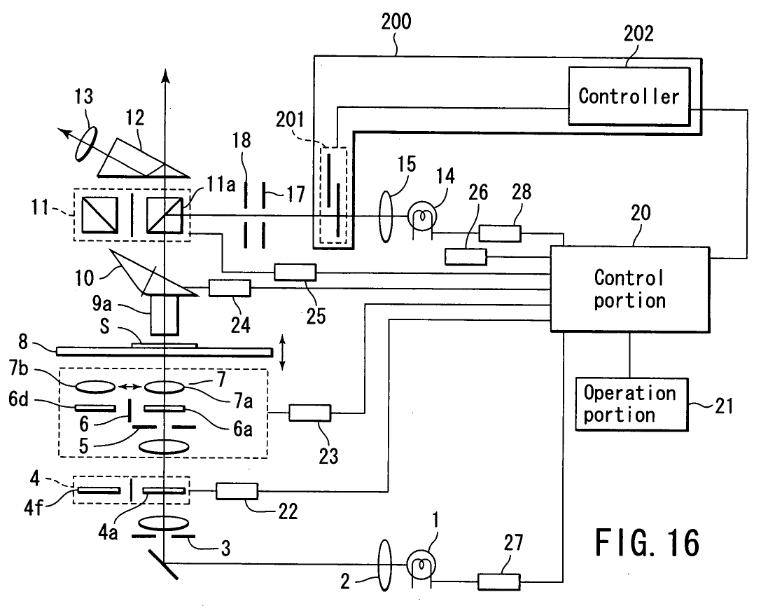

FIG. 16 is an overall structural view of an electric optical microscope. In this electric optical microscope, the reflected-light filter turret 16 is eliminated from the electric optical microscope described in connection with the first embodiment, and a high-speed shutter system 200 is connected as an external peripheral device.

The high-speed shutter system 200 has a high-speed shutter 201 and a controller 202. The high-speed shutter 201 and the controller 202 are connected to each other through a cable.

The controller 202 is connected to an external host device H such as a personal computer PC through, e.g., RS-232C as an external communication cable. The controller 202 receives a command inherent to the high-speed shutter system 200 from the external host device H, and controls to open/close the high-speed shutter system 201.

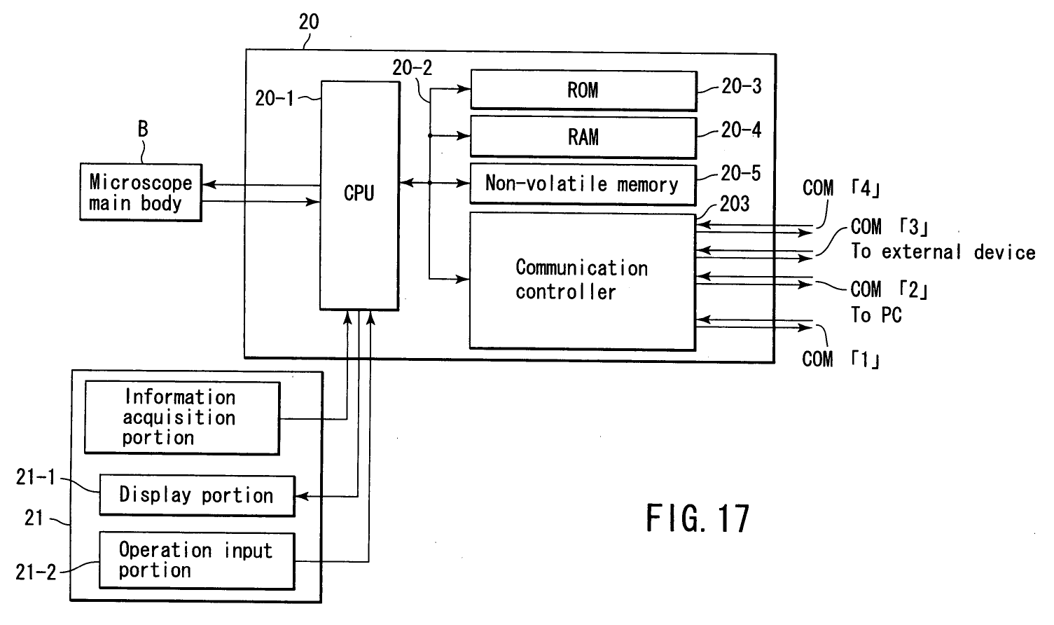

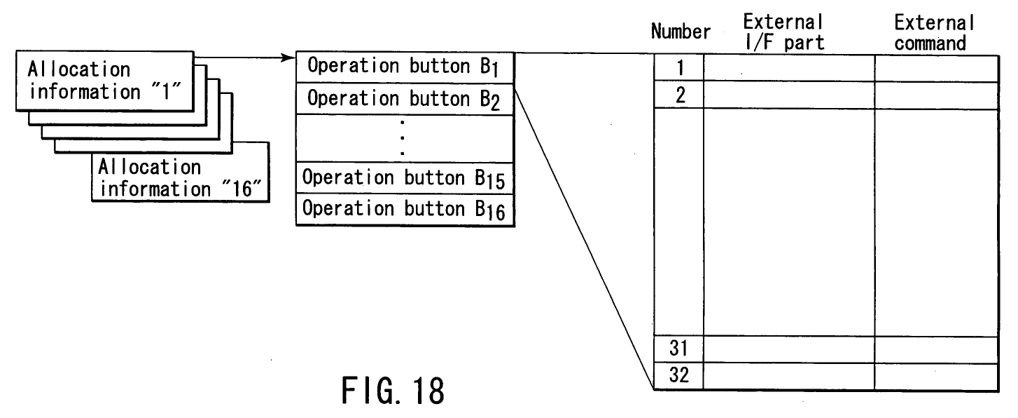

FIG. 17 is a structural view of the control portion 20 and the operation portion 21. It is to be noted that like reference numerals denote parts equal to those in FIG. 2, thereby eliminating their detailed description. A communication controller 203 is connected to the CPU 20-1 through a CPU bus 20-2.

The communication controller 203 serves as an external I/F which performs data communication between the CPU 20-1 and the external peripheral device.

The CPU 20-1 provides four channel COM terminals “1” to “4” used to connect the external peripheral device. For example, the personal computer PC is connected to the COM terminal “1”. The high-speed shutter system 200 is connected to the COM terminal “3”. The external peripheral device is, e.g., the high-speed shutter system 200 or the personal computer PC.

Like the first embodiment, the non-volatile memory 20-5 stores therein allocation information allocated to respective operation buttons B₁ to B₁₆ shown in FIGS. 9 to 11. The allocation information is fetched from, e.g., the external personal computer PC through the external I/F, and allocated to the respective operation buttons B₁ to B₁₆.

Information used to perform an operation control over an external peripheral device such as the high-speed shutter system 200 (which will be referred to as allocation information hereinafter) is allocated to the respective operation buttons B₁ to B₁₆ and stored in the non-volatile memory 20-5.

The allocation information is fetched from, e.g., the external personal computer PC through the external I/F, allocated to the respective operation buttons B₁ to B₁₆, and stored. The allocation information has numbers for the respective operation buttons B₁ to B₁₆, an external I/F part, and an external command.

The CPU 20-1 reads from the non-volatile memory 20-5 the allocation information used to perform an operation control over an external peripheral device such as the high-speed shutter system 200 allocated to the manipulated operation buttons B₁ to B₁₆.

Subsequently, the CPU 20-1 executes the operation control over an external peripheral device such as the high-speed shutter system 200 in accordance with the allocation information.

An allocation information setting operation of the high-speed shutter system 200 with respect to the electric optical microscope having the above-described structure will now be described.

First, the allocation information of a closing control of the high-speed shutter system 200 is set to the operation button B₉ of the allocation information “1”. The setting operation is performed by fetching a command of the high-speed shutter system 200 from the personal computer PC connected to the COM terminal “1”.

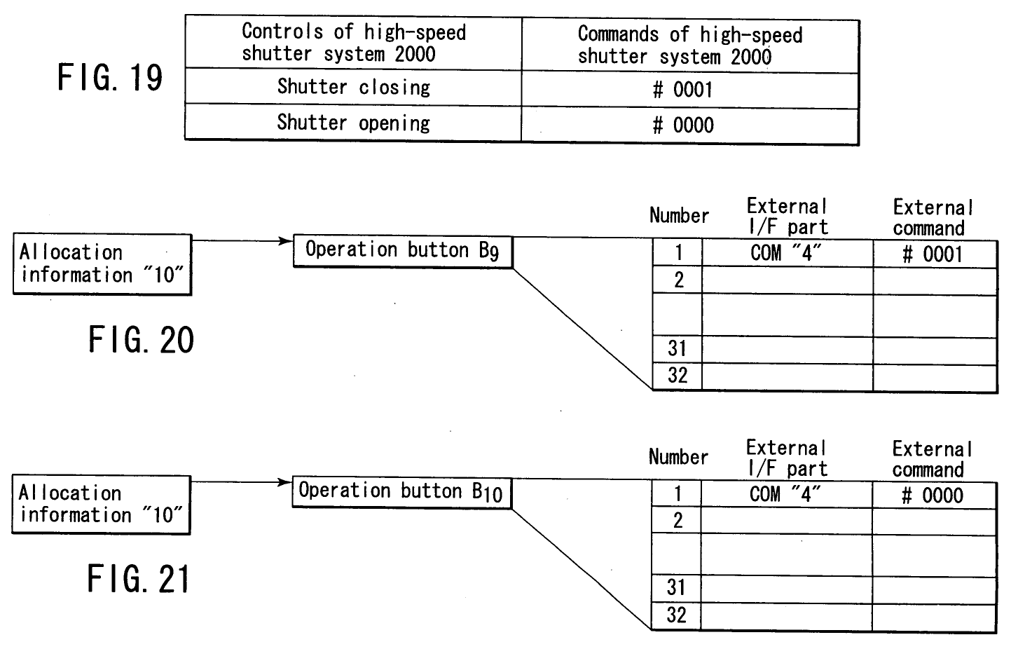

FIG. 19 shows commands of the high-speed shutter system 200. A command for shutter opening of the high-speed shutter system 200 is “#0001”, and a command for shutter closing is “#0000”.

The CPU 20-1 receives, e.g., the following command to perform a shutter closing control over the high-speed shutter system 200 from the personal computer PC through the communication controller 203:

“memory 10,9,COM4:“#0001”

Then, the CPU 20-1 erases stored data in a corresponding area of the non-volatile memory and newly writes the allocation information in accordance with parameters in the command.

That is, the CPU 20-1 starts setting of the allocation information based on a parameter “memory” in the command. The CPU 20-1 determines the allocation information “10” stored in the non-volatile memory 20-5 as a corresponding area based on a first parameter “10” in the command. Then, the CPU 20-1 sets the operation button B₉ as a setting target from the allocation information based on a next parameter “9” in the command.

Subsequently, the CPU 20-1 determines the number as “1”, set an external I/F part as the COM terminal “4”, and sets the external command as “#0001” based on a parameter “COM4: #0001”.

As a result, as shown in FIG. 20, the setting to transmit the external command “#0001” to the external I/F and the COM terminal “4” is written in the operation button B₉ of the allocation information “10”.

Further, the CPU 20-1 receives, e.g., the following command to execute a shutter opening control over the high-speed shutter system 200 from the personal computer PC through the communication controller 203:

“memory 10,10,COM4:“#0000”

Then, the CPU 20-1 starts setting of the allocation information based on a parameter “memory” in the command. The CPU 20-1 determines the allocation information “10” stored in the non-volatile memory 20-5 as a corresponding area based on a first parameter “10” in the command. Subsequently, the CPU 20-1 sets the operation button B₁₀ as a setting target from the allocation information “10” based on a next parameter “10” in the command.

Then, the CPU 20-1 determines the number as “1” based on a parameter “COM4:#0000” in the command. Thereafter, the CPU 20-1 sets an external I/F part as the COM terminal “4” and determines an external command as “#0000”.

As a result, in the non-volatile memory 20-5, as shown in FIG. 21, the setting to transmit the external command “#0000” to the external I/F and the COM terminal “4” is written in the operation button B₁₀ of the allocation information “10”.

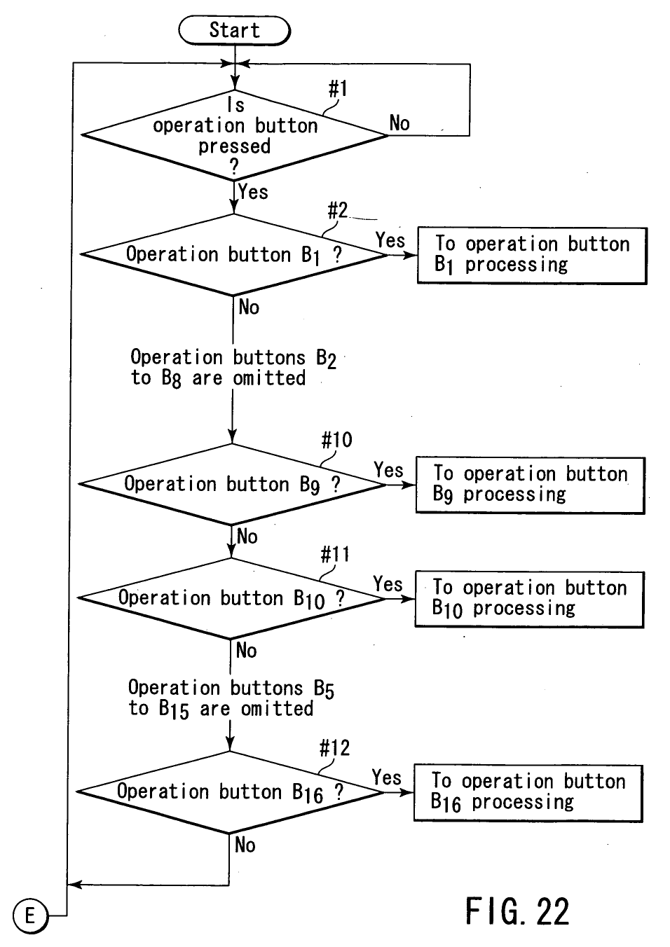

The operation of the electric optical microscope having the above-described structure will now be described in accordance with allocation operation control flowcharts shown in FIGS. 22 to 24.

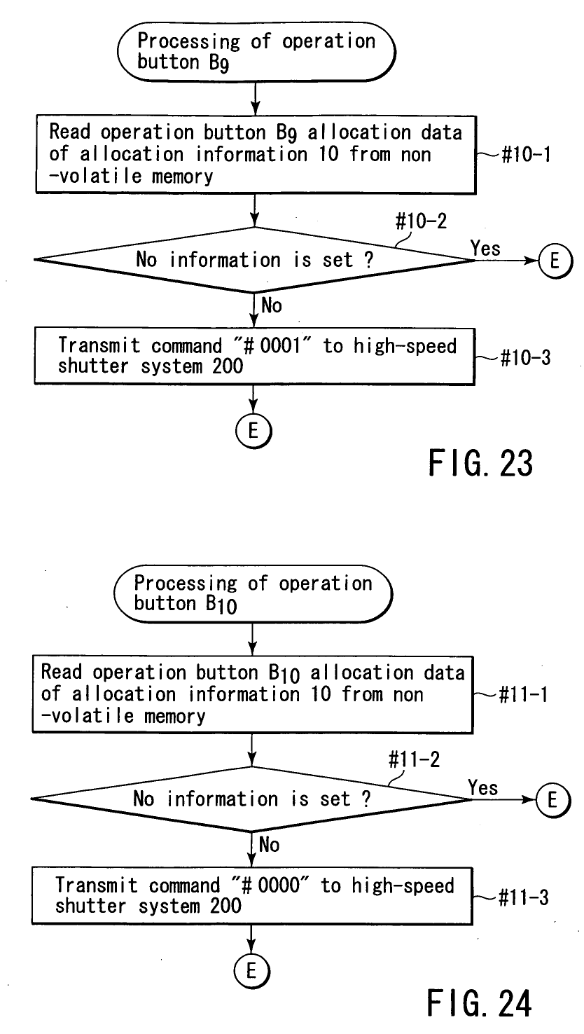

The CPU 20-1 judges presence/absence of the operations of the respective operation buttons B₁ to B₁₆ at a step #1. When the operation button B₉ is pressed, the CPU 20-1 shifts to a step #10 and detects a pressing operation of the operation button B₉. The CPU 20-1 starts processing of the operation button B₉ shown in FIG. 23, i.e., driving of the respective electric mechanisms corresponding to the operation button B₉.

Then, at a step #10-1, the CPU 20-1 reads the allocation information “10” selected by the DIP-SW provided to the control portion 20 from the non-volatile memory 20-5. It is to be noted that, at a step #10-2, if any part is not set in the allocation information “10” read from the non-volatile memory 20-5, the CPU 20-1 does not perform any processing and waits for an operation input of the next operation buttons B₁ to B₁₆.

Subsequently, at a step #10-3, the CPU 20-1 transmits the external command “#0001” to the high-speed shutter system 200 through the COM terminal “4” in accordance with the allocation information read from the non-volatile memory 20-5.

Upon receiving the external command “#0001” by the controller 202, the high-speed shutter system 200 immediately closes the high-speed shutter 201.

Then, when the operation button B₁₀ is pressed, the CPU 20-1 shifts to a step #11 and detects a pressing operation of the operation button B₁₀. The CPU 20-1 starts processing of the operation button B₁₀ shown in FIG. 24, i.e., driving of the respective electric mechanisms corresponding to the operation button B₁₀.

Thereafter, at a step #11-1, the CPU 20-1 reads the allocation information “10” selected by the DIP-SW provided to the control portion 20 from the non-volatile memory 20-5. It is to be noted that, at a step #11-2, if any part is not set in the allocation information “10” read from the non-volatile memory 20-5, the CPU 20-1 does not perform any processing and waits for an operation input of the next operation buttons B₁ to B₁₆.

Then, at a step #11-3, the CPU 20-1 transmits the external command “#0000” to the high-speed shutter system 200 through the COM terminal “4” in accordance with the allocation information read from the non-volatile memory 20-5.

Upon receiving the external command “#0000” by the controller 202, the high-speed shutter system 200 immediately opens the high-speed shutter 201.

As described above, according to the second embodiment, the allocation information of, e.g., the high-speed shutter system 200 as the external peripheral device is fetched from, e.g., the external personal computer PC through the external I/F, allocated to the respective operation buttons B₁ to B₁₆, and stored in the non-volatile memory 20-5. The CPU 20-1 reads the allocation information allocated to the manipulated operation buttons B₁ to B₁₆ from the non-volatile memory 20-5, and applies an operation control to the high-speed shutter system 200 in accordance with the allocation information.

As a result, even if, e.g., the high-speed shutter system as the external peripheral device is connected to the electric optical microscope, the operation of the high-speed shutter system 200 can be arbitrarily controlled by the operation of the respective operation buttons B₉ and B₁₀.

Since the allocation information of the high-speed shutter system 200 is stored in the non-volatile memory 20-5, a computer used to control the high-speed shutter system 200 does not have to be additionally connected. Consequently, even when the high-speed shutter system 200 is operated with the operation of the electric optical microscope, the flexible and high operability can be obtained.

Since the allocation information of the high-speed shutter system 200 is allocated to the arbitrary operation buttons B₁ to B₁₆, the information can be allocated to the operation buttons B₁ to B₁₆ which are explicit to operate the high-speed shutter system 200. Furthermore, by discriminating arrangement positions of the operation button which performs the operation control over the high-speed shutter system 200 and the operation button which carries out the operation control over each optical element of the electric optical microscope, the arrangements of these operation buttons become clear, thereby further improving the operability.

The external peripheral device to be connected to the electric optical microscope is not restricted to the high-speed shutter system 200, and a high-speed filter turret or the like may be connected. The number of the external peripheral device to be connected to the electric optical microscope is not restricted to one, and a plurality of the devices may be connected in accordance with the number of the respective operation buttons B₁ to B₁₆.

Although the high-speed shutter system 200 performs the shutter opening and shutter closing operations, it can perform complicated operation controls depending on an operation content of the external peripheral device.

Therefore, according to the second embodiment, the external peripheral device having various performances on the market can be connected to the electric optical microscope without restricting to a specific external peripheral device. As a result, construction to a system desired by a user of the electric optical microscope can be more flexibly realized.

It is to be noted that the present invention is not restricted to the first and second embodiments, and it can be modified in many ways without departing from the scope of the invention on an embodying stage.

For example, a plurality of the electric optical microscopes according to the present invention may be connected to the host computer through the communication controller 203 in the second embodiment. If such a structure is adopted, allocation information which is indicative of respective optical elements and their arrangement states and allocated to the respective operation buttons B₁ to B₁₆ can be transmitted from the host computer to a plurality of the electric optical microscopes. The allocation information at this moment may have the same content or a content which differs in accordance with each electric optical microscope. Moreover, allocation information used to operate the external peripheral device may be adopted. Additionally, each allocation information of a plurality of the electric optical microscope can be managed by the host computer.

The allocation information may be fetched to the control portion 20 of the electric optical microscope through the Internet and stored in the non-volatile memory 20-5.

What is claimed is:

1. An electric optical microscope comprising:
an illumination optical system which illuminates a sample with illumination light rays;
an observation optical system which receives observation light rays from the sample and obtains an enlarged image of the sample;
a plurality of optical elements which realize a plurality of observation methods with respect to the sample by being selectively arranged~on respective optical paths of the illumination optical system and the observation optical system;
an operation portion having arranged thereto a plurality of operation input ends used to indicate any one of a plurality of the observation methods;
a storage portion which allocates operation input allocation information indicative of the optical elements selected in accordance with a plurality of the observation methods and arrangement states of the optical elements on the respective optical paths of the illumination optical system and the observation optical system to a plurality of the operation input ends, and stores it therein;
a control portion which reads the operation input allocation information allocated to the operation portion from the storage portion upon detecting an operation to the operation input end, and arranges the optical elements on the respective optical paths of the observation optical system and the illumination optical system in accordance with the operation input allocation information; and
an information setting portion which fetches the operation input allocation information from the outside through a communication line, allocates the fetched operation input allocation information to any one of a plurality of the operation input ends, and stores it in the storage portion.

2. The electric optical microscope according to claim 1, wherein a plurality of the observation methods are at least a bright field observation method, a dark field observation method, a differential interference observation method, a phase difference observation method, a fluorescent observation method, and a composite observation method which is a combination of the respective observation methods.

3. The electric optical microscope according to claim 1, wherein a plurality of the optical elements are at least permeation filter, a condenser lens, an object lens, a cube cassette having a plurality of filter cubes attached thereto which constitute the observation optical system, and
they are at least a permeation illumination light source, a permeation filter turret, a permeation aperture diaphragm, a reflected illumination light source, a reflected filter turret which constitute the illumination optical system.

4. The electric optical microscope according to claim 1, wherein a plurality of the operation input ends are respective operation button switches.

5. The electric optical microscope according to claim 1, wherein the operation portion has a display portion which displays the arrangement states of the optical elements.

6. The electric optical microscope according to claim 1, wherein the operation input allocation information stored in the storage portion is at least a bright field observation method, a dark field observation method, a differential interference observation method, a phase difference observation method, a fluorescent observation method, and a composite observation method which is a combination of the respective observation methods as a plurality of the observation methods, and
a plurality of the optical elements are at least a permeation filter, a condenser lens, an object lens, a cube cassette having a plurality of filter cubes attached thereto, a permeation illumination light source, a permeation filter turret, a permeation aperture diaphragm, a reflected illumination light source, and a reflected filter turret arranged on the respective optical paths of the illumination optical system and the observation optical system in accordance with a plurality of the observation methods.

7. The electric optical microscope according to claim 1, wherein the storage portion is a non-volatile memory.

8. The electric optical microscope according to claim 1, wherein the operation input allocation information consists of a plurality of sets of allocation information, and
a plurality of sets of the allocation information are respectively allocated to a plurality of the operation input ends and stored, and are indicative of arrangement states of a plurality of the optical elements on the respective optical paths of the observation optical system and the illumination optical system according to a plurality of the observation methods.

9. The electric optical microscope according to claim 8, wherein a plurality of sets of the allocation information indicate arrangement states of at least a permeation filter, a condenser lend, an object lens, a cube cassette having a plurality of filter cubes attached thereto, a permeation illumination light source, a permeation filter turret, a permeation aperture diaphragm, a reflected illumination light source, and a reflected filter turret as a plurality of the optical elements on the respective optical paths of the observation optical system and the illumination optical system according to at least a bright field observation method, a dark field observation method, a differential interference observation method, a phase difference observation method, a fluorescent observation method, and a composite observation method which is a combination of the respective observation methods as a plurality of the observation methods.

10. The electric optical microscope according to claim 8, wherein the storage portion can add, change and delete a plurality of sets of the allocation information.

11. The electric optical microscope according to claim 9, wherein the storage portion can add, change and delete a plurality of sets of the allocation information.

12. The electric optical microscope according to claim 1, wherein, upon detecting an operation to the operation input end, the control portion reads the operation input allocation information allocated to the manipulated operation input end from the storage portion, and executes a program having described therein a command to arrange the optical elements on the respective optical paths of the observation optical system and the illumination optical system in accordance with the operation input allocation information.

13. The electric optical microscope according to claim 1, wherein the control portion exchanges information with an external host device through the communication line.

14. The electric optical microscope according to claim 1, wherein the information setting portion allocates the operation input allocation information fetched from an external host device through the communication line to any one of a plurality of the operation input ends, and stores it in the storage portion.

15. The electric optical microscope according to claim 14, wherein the external host device is a personal computer which transmits the operation input allocation information.

16. The electric optical microscope according to claim 1, having an external peripheral device attached to an electric optical microscope main body,
wherein the storage portion allocates information to perform an operation control over the external peripheral device to any one of a plurality of the operation input ends, and stores it therein.

17. The electric optical microscope according to claim 16, wherein the external peripheral device is a high-speed shutter system which opens/closes a shutter relative to the optical path of the illumination optical system.

18. The electric optical microscope according to claim 1, wherein the information setting portion allocates the operation input allocation information of the external peripheral device fetched from the external host device through the communication line to any one of a plurality of the operation input ends, and stores it therein.

19. The electric optical microscope according to claim 18, wherein the information setting portion allocates each of the operation input allocation information of a plurality of the external peripheral devices to each of a plurality of the operation input ends, and stores them therein.
